(19) United States
(12) Patent Application Publication
(10) Pub. No.: US 2021/0063332 A1
(43) Pub. Date: Mar. 4, 2021

(54) SPLIT CYLINDER RESONATOR AND METHOD OF CALCULATING PERMITTIVITY

(71) Applicant: EM labs, Inc., Kobe (JP)

(72) Inventor: Yoshiyuki YANAGIMOTO, Kobe (JP)

(73) Assignee: EM labs, Inc.

(21) Appl. No.: 16/805,835

(22) Filed: Mar. 2, 2020

(30) Foreign Application Priority Data
Sep. 4, 2019 (JP) 2019-161539

(51) Int. Cl. G01N 27/02; H01P 7/06; H01P 3/06; H01Q 7/00

(52) U.S. Cl. CPC G01N 27/02; H01Q 7/00; H01P 3/06; H01P 7/06

(57) ABSTRACT

A split cylinder resonator has: a first conductive body having a first cavity formed in a cylindrical shape having the side surface and the bottom surface; a second conductive body having a second cavity formed in a cylindrical shape having the side surface and the bottom surface and arranged so that the second cavity faces the first cavity; first and second coaxial cables respectively having first and second loop antennas at a tip, the first and second loop antennas being exposed to an integrated cavity which is formed by the first cavity and the second cavity, the first and second coaxial cables facing each other. Each of the first conductive body and the second conductive body has a protruded portion protruded from a part of at least one of the side surface and the bottom surface of the first conductive body and the second conductive body toward the integrated cavity.

### CROSS-REFERENCES TO RELATED APPLICATIONS

This patent specification is based on Japanese patent application, No. 2019-161539 filed on Sep. 4, 2019 in the Japan Patent Office, the entire contents of which are incorporated by reference herein.

### BACKGROUND OF THE INVENTION

### 1. Field of the Invention

The present invention relates to a split cylinder resonator which is a measurement device of complex permittivity (complex dielectric constant) of dielectric material and related to a method of calculating the complex permittivity using the device. Especially, the present invention relates to the measurement device suitable for measuring the complex permittivity of the dielectric material in a microwave and millimeter wave bands.

### 2. Description of the Related Art

For measuring the complex permittivity of the dielectric material in the microwave band, Cavity resonator perturbation method, Transmission line method, Fabry-Perot resonator method, Balanced-type circular disk resonator method, Split-type cylindrical cavity resonator method (hereafter, referred to as “split cylinder method”), Circular cut-off waveguide resonator method and other methods are practically used. The measurement of the complex permittivity using the resonator is suitable for measuring a low-loss sample. Thus, various methods have been considered other than the above described methods. In the explanation below, “real part of complex permittivity” may be referred to as “permittivity,” and a ratio of “imaginary part of complex permittivity” with respect to “real part of complex permittivity” may be referred to as “dielectric tangent” (imaginary part of complex permittivity/real part of complex permittivity).

There are various types of resonances of the resonator. Thus, the resonance frequency varies depending on the shape of resonators. For measuring the complex permittivity in the desired resonance frequency, there are various methods for inserting samples. When the complex permittivity is measured using the resonator, as shown in FIG. 18, the resonance characteristics (center frequency Fempty and Q-factor Qempty) in the empty state (without measurement sample) and the resonance characteristics (center frequency Fsample and Q-factor Qsample) in the state where the measurement sample is inserted (with measurement sample) are measured independently, and then the complex permittivity of the measurement sample is obtained by calculation or simulation. Here, “Q-factor” is an index showing the sharpness of resonance. In general, the Q-factor is the value obtained by dividing the resonance frequency by the band width where the transmission coefficient (S21) is reduced by 3 dB from the peak. However, other definitions also exist.

The Cavity resonator perturbation method is the most frequently used method in the ranges of 1 GHz to 10 GHz. However, in the 5G communication (fifth-generation mobile communications system), the millimeter wave band which has higher frequency is used for expanding a network communication capacity. Thus, the frequencies such as 28 GHz and 40 GHz are used. Also in an automotive radar, the millimeter wave band having a short wavelength is used for increasing the detection resolution of the objects. Thus, the frequencies such as 24 GHz and 76 GHz are mainly used. For measuring the complex permittivity of the above described millimeter wave band, a sample insertion hole is too small in the above described Cavity resonator perturbation method and it is difficult to actually measure the complex permittivity.

In the split cylinder method, the measurement can be performed easily and correctly with good reproducibility in the millimeter wave band. Thus, the split cylinder method is expected to be most appropriate for measuring high frequency dielectric materials which will be more frequently used when the technology is applied to the 5G communication and the automotive radar.

The split cylinder method uses a split cylinder resonator having a shape of combining two conductive bodies where half cavities (bottomed cavities having a cylindrical shape) of the two conductive bodies are placed facing (opposite to) each other. FIG. 19 is a schematic diagram showing a cross-section of a split cylinder resonator 800 for explaining the concept of the split cylinder method. Two conductive bodies 81, 82 are formed by opening half cavities on the metal having high electric conductivity such as copper and silver. Then, the two conductive bodies 81, 82 are joined together on a joint surface F so that one cavity 89 is formed by combining two half cavities. Coaxial cables 13, 14 are inserted into the cavity 89 for inputting and detecting signals, and two small-sized loop antennas are provided at the tips of the coaxial cables 13, 14 and arranged in the cavity. A measurement sample Sa is inserted into a gap (joint surface F) formed by dividing the two half cavities. As shown in FIG. 18, the resonance characteristics (center frequency: Fempty; Fsample and Q-factor: Qempty; Qsample) are measured under both conditions with and without the sample, and the complex permittivity of the measurement sample Sa is obtained by calculation or simulation.

As shown in FIG. 20, there are a plurality types of resonance modes in the split cylinder method. In the TE mode, the complex permittivity can be measured regardless of the resonance modes to be used. An electric field is generated in parallel with the bottom surface of the resonator in the TE mode. Thus, if the measurement sample Sa is inserted in parallel with the bottom surface of the conductive bodies 81, 82, the resonance frequency is shifted (changed) and the complex permittivity can be obtained.

However, the TE011 mode is used mainly in the split cylinder method. This is because of the following reasons. The first reason is that the Q-factor of the resonance can be larger and the low-loss dielectric material can be more accurately measured. In the resonance of the TE011 mode, the Q-factor of the resonance becomes larger because the current distribution flowing on the wall surface of the metal forming the resonator is simple and the loss caused by the electric resistance can be kept low. The second reason is that the electric field can be evenly applied to the sample. In the TE011 mode, the electric field distribution inside the resonator is formed in a simple circular shape. In other high order modes, the electric field is unevenly distributed and the result is easily influenced by the unevenness of the sample characteristics in the surface. In addition, the TE mode has a common advantage that the current distribution surrounds the circumference of the resonator. Thus, the influence is small even if the resonator is divided into two and the sample can be inserted as shown in FIG. 19.

As explained above, although the TE011 mode performs the best in the resolution of the split cylinder method, the TE011 mode is degenerated into the resonance of the TM111 mode. Namely, as shown in Formula (1) and Formula (2), since the values are equal (J′01=J11=3.8317), the resonance frequency Fte011 of the TE011 mode and the resonance frequency Ftm111 of the TM111 mode are equal (degenerated). In the resonance frequency characteristics before inserting the sample into the split cylinder resonator (vacant resonator), the frequency of the TM111 mode which is the resonance mode different from the TE011 mode exists (is degenerated) overlapping with the completely same frequency of the TE011 mode. Thus, an error is caused when measuring the resonance frequency in TE011 mode under the influence of the TM111 mode. As a result, the value of the permittivity is incorrectly measured.

Fte011=(c*\sqrt{ }((J′01/D)\hat{ }2+(π/H)\hat{ }2)))/(2*π) (1)

Ftm111=(c*\sqrt{ }((J11/D)\hat{ }2+(π/H)\hat{ }2)))/(2*π) (2)

J′01: the first zero point of the derivative of Bessel functions of the first kind of order 0

J11: the first zero point of Bessel functions of the first kind of order 1

In order to solve the above described problem, Non-Patent Document 1 discloses a cylindrical cavity resonator having grooves for separating the degenerate mode. Narrow grooves are provided on the outer peripheries of the upper surface and lower surface of the resonator. Thus, the resonance frequency of the TM111 mode is shifted to the low frequency side without affecting the TE011 mode almost at all. FIG. 21 is schematic diagram showing a cross-section of a split cylinder resonator 900 wherein grooves 95, 96 are formed on the periphery of the bottom surface of the conductive bodies 91, 92. Because of the grooves 95, 96, the resonance frequency of the TM111 mode is shifted to the low frequency side without affecting the TE011 mode almost at all. FIG. 22 shows the measurement result of the resonances of the TE011 mode and the TM111 mode by installing the coaxial cables 13, 14 in a cavity 99 of the split cylinder resonator 900 processed as described above. It is confirmed that the resonance frequencies of the TE011 mode and the TM111 mode are separated with each other.

However, in the above described method, there is a large restriction for the measurable sample. FIG. 23 shows the resonances of the TE011 mode and the TM111 mode when a polyimide sheet having a thickness of approximately 150 μm is inserted into the cylindrical cavity resonator (28 GHz) shown in FIG. 21 having the grooves for separating the degenerate mode. The resonance frequency of the TM111 mode is not affected a lot by the dielectric material and the frequency shift of the TM111 mode resonance is not as large as that of the TE011 mode. The resonance frequency of the TE011 mode is significantly shifted to the low frequency side. As a result, both resonance frequencies are almost overlapped with each other. In the above described state, it is not possible to correctly measure only the resonance characteristics of the TE011 mode. The polyimide sheet having a thickness of approximately 150 μm is very commonly used for the circuit board of the millimeter wave band, and is required to be precisely measured by the split cylinder resonator.

When the polyimide sheet having the thickness thicker than 150 μm or having higher permittivity is used, the resonance frequency of the TE011 mode is shifted to the frequency lower than the resonance frequency of the TM111 mode. Thus, the TE011 mode is separated from the TM111 mode again and the measurement is possible. However, when the properties of the inserted sample are unknown, whether or not the resonance frequency of the TE011 mode is lower than the resonance frequency of the TM111 mode cannot be judged. In a state that the resonance frequency of the TE011 is lowered, it is extremely difficult to distinguish the TE011 mode from the TM111 mode. In particular, it is unrealistic to make the above described judgement by the software of automatically and easily finding the TE011 mode.
[Non-Patent Document 1] Takashi SHIMIZU et. al, “Design of a Grooved Circular Cavity for Dielectric Substrate Measurements in Millimeter Wave Region” p. 1715-1720, IEICE TRANS. ELECTRON., VOL. E 86-C, NO. 8, AUGUST 2003

### BRIEF SUMMARY OF THE INVENTION

In the cylindrical cavity resonator having grooves for separating the degenerate mode shown Non-Patent Document 1, the resonance frequency of the TE011 mode is separated by lowering the resonance frequency of the TM111 mode. However, when the frequency is measured by inserting the dielectric material (i.e., measurement sample) into the split cylinder resonator, the resonance frequency of the TE011 mode is lowered compared to the case when the measurement sample is not inserted. Thus, the resonance frequencies of the TM111 mode and the TE011 mode are close to each other (overlapped in some cases) and the resonance characteristics may not be measured correctly.

The present invention aims for providing a split cylinder resonator capable of correctly measuring the complex permittivity of a dielectric sheet (film) frequently used for the 5G communication and the automotive radar without being affected by the TM111 mode.

For solving the above described problems, the split cylinder resonator includes a first conductive body having a first cavity formed in a cylindrical shape having the side surface and the bottom surface; a second conductive body having a second cavity formed in a cylindrical shape having the side surface and the bottom surface, the second conductive body being arranged so that the second cavity faces the first cavity; a first coaxial cable having a first loop antenna at a tip of the first coaxial cable, the first loop antenna being arranged so as to be exposed to an integrated cavity which is formed by the first cavity and the second cavity; and a second coaxial cable having a second loop antenna at a tip of the second coaxial cable, the second loop antenna being arranged so as to be exposed to the integrated cavity, the second coaxial cable being arranged so as to face the first coaxial cable. The first conductive body and the second conductive body have a protruded portion protruded from a part of at least one of the side surface and the bottom surface of the first conductive body and the second conductive body toward the integrated cavity.

In addition, a method of calculating a permittivity of the present invention is the method of calculating the permittivity of a dielectric material as a measurement sample using a split cylinder resonator. The method of calculating the permittivity includes a step of obtaining a first resonance characteristics before the dielectric material is set to the split cylinder resonator; a step of obtaining a second resonance characteristics after the dielectric material is set to the split cylinder resonator; a step of judging the lowest resonance in a range higher than a preliminarily known resonance frequency of TM110 mode and regarding the judged resonance as the resonance of TE011 mode; and a step of calculating the permittivity of the dielectric material based on the first resonance characteristics and the second resonance characteristics.

In the split cylinder resonator of the present invention, the resonance frequency of the TM111 mode becomes higher than the resonance frequency of the TE011 mode by the protruded portion provided on the cavity. Thus, even when the resonance frequency of the TE011 mode is lowered by inserting the sample of the dielectric material to be measured, the resonance frequency of the TE011 mode does not become close to the resonance frequency of the TM111 mode. Consequently, the complex permittivity can be measured correctly without being affected by the TM111 mode.

### BRIEF DESCRIPTION OF THE DRAWINGS

FIG. 1 is a schematic diagram showing a cross-section of a split cylinder resonator (without measurement sample) of an embodiment.

FIG. 2 is a schematic diagram showing a cross-section of the split cylinder resonator (with measurement sample) of an embodiment.

FIG. 3 is a drawing showing the resonance frequency characteristics of the split cylinder resonator (without measurement sample) of an embodiment.

FIG. 4 is a drawing showing the resonance frequency characteristics of the split cylinder resonator (with measurement sample) of an embodiment.

FIG. 5 is a drawing showing the resonance frequency characteristics of the split cylinder resonators of an embodiment when the size of the cavity is changed.

FIG. 6 is the drawing showing the size of the cavity of the split cylinder resonators used in FIG. 5.

FIG. 7 is a schematic diagram showing a cross-section of a split cylinder resonator of the modified example 1 of an embodiment.

FIG. 8 is a schematic diagram showing a cross-section of a split cylinder resonator of the modified example 2 of an embodiment.

FIG. 9 is a schematic diagram showing a cross-section of a split cylinder resonator of the modified example 3 of an embodiment.

FIG. 10 is a schematic diagram showing a cross-section of a split cylinder resonator of the modified example 4 of an embodiment.

FIG. 11 is a drawing showing the relation between the cross-sectional area of the protruded portion and the resonance frequency of the split cylinder resonator of an embodiment.

FIG. 12 is a drawing showing the resonance frequency characteristics (case 1) of the split cylinder resonator of an embodiment.

FIG. 13 is a drawing showing the resonance frequency characteristics (case 2) of the split cylinder resonator of an embodiment.

FIG. 14 is a drawing showing the resonance frequency characteristics (case 3) of the split cylinder resonator of an embodiment.

FIG. 15 is a drawing showing the resonance frequency characteristics (case 4) of the split cylinder resonator of an embodiment.

FIG. 16 is a drawing showing the resonance frequency characteristics (case 5) of the split cylinder resonator of an embodiment.

FIG. 17 is a drawing showing the relation (cases 1-5) between the cross-sectional area of the protruded portion of the split cylinder resonator and the measurement accuracy of an embodiment.

FIG. 18 is a drawing showing the resonance frequency characteristics of the split cylinder resonator.

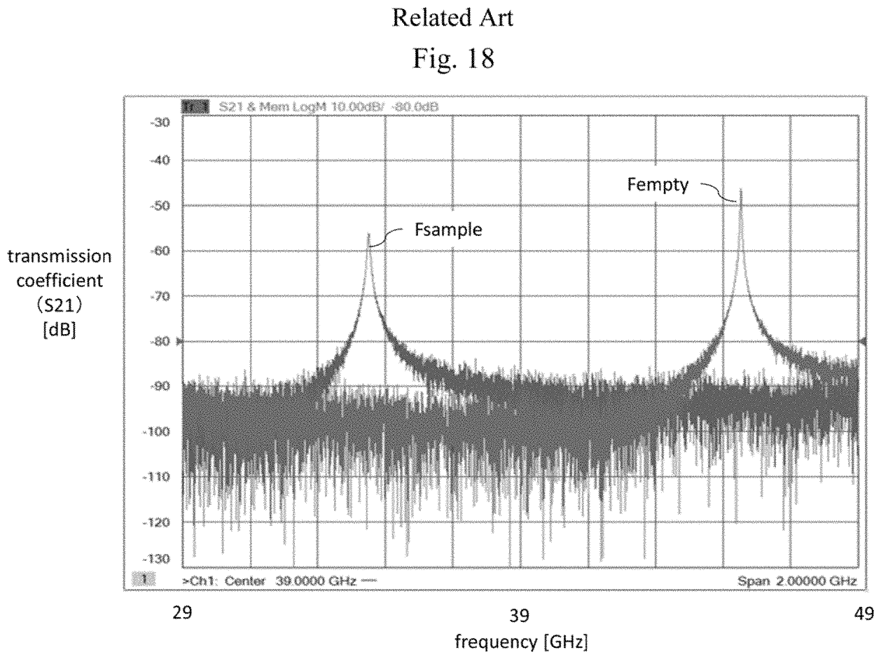

FIG. 19 is a schematic diagram showing a cross-section of the split cylinder resonator (with measurement sample) for explaining the concept of the split cylinder method.

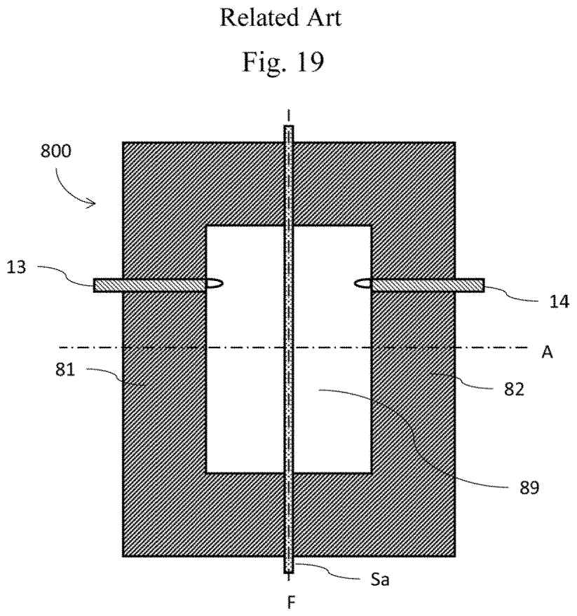

FIG. 20 is a drawing showing the resonance frequency characteristics (without measurement sample) of the split cylinder resonator of the conventional technology.

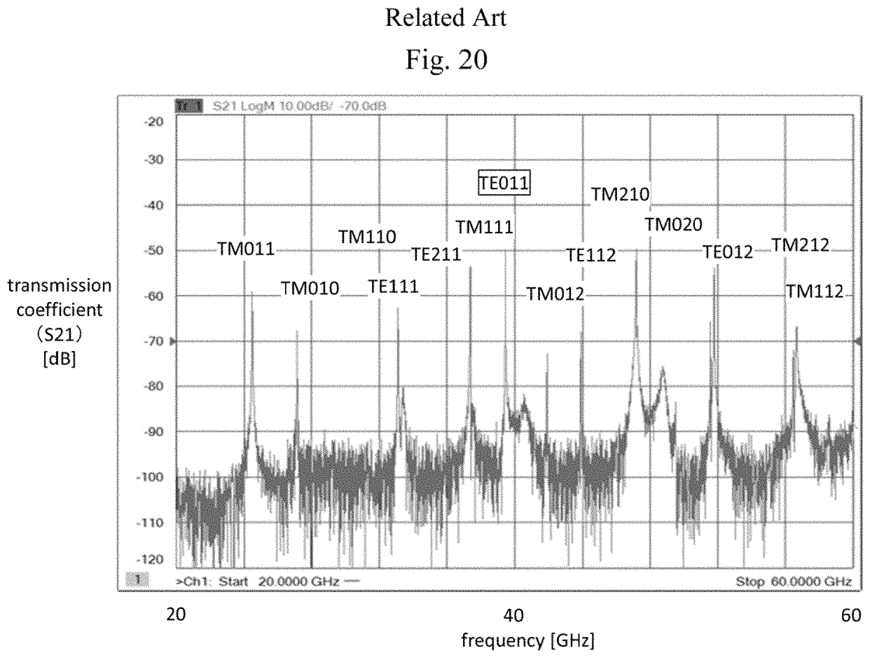

FIG. 21 is a schematic diagram showing a cross-section of the split cylinder resonator disclosed in Non-Patent Document 1.

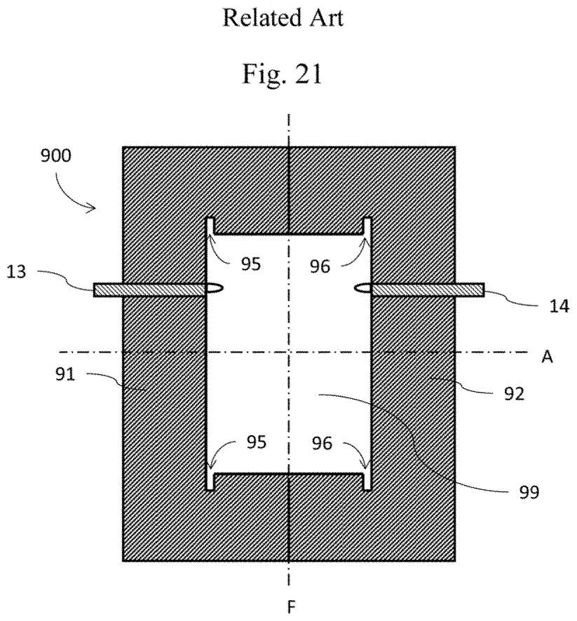

FIG. 22 is a drawing showing the resonance frequency characteristics (without measurement sample) of the split cylinder resonator disclosed in Non-Patent Document 1.

FIG. 23 is a drawing showing the resonance frequency characteristics (with measurement sample) of the split cylinder resonator disclosed in Non-Patent Document 1.

### DETAILED DESCRIPTION OF THE INVENTION

### Embodiments

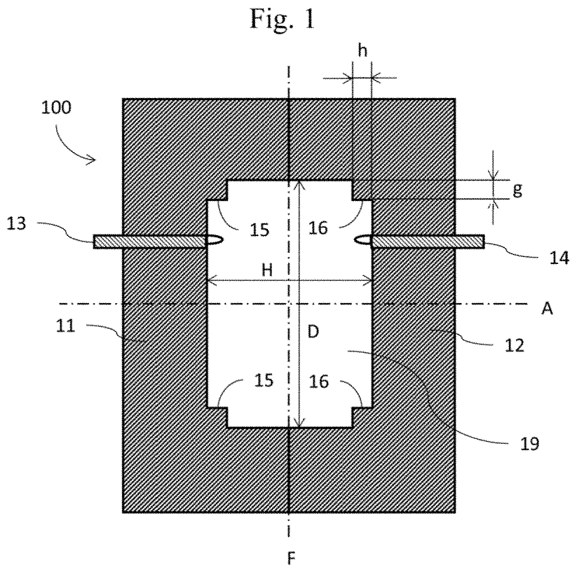

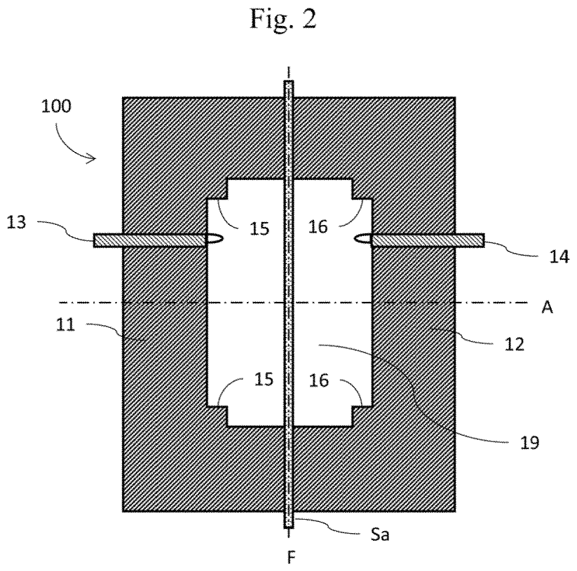

FIG. 1 is a schematic diagram showing a cross-section of a split cylinder resonator (without measurement sample). FIG. 2 is a schematic diagram showing a cross-section of the split cylinder resonator in which the measurement sample is inserted. A split cylinder resonator 100 has two conductive bodies 11, 12 and two coaxial cables 13, 14. The two conductive bodies 11, 12 have the bottomed cavities which have the substantially same shape with each other. The split cylinder resonator 100 is formed by combining the conductive bodies 11, 12 so that the bottomed cavities face with each other. The bottomed cavities are formed in a cylindrical (circular columnar) shape having the side surface and the bottom surface so that opening portion is located opposite to the bottom surface. A cavity 19 (integrated cavity) having a cylindrical shape is formed by combining the bottomed cavity of the conductive body 11 and the bottomed cavity of the conductive body 12. Protruded portions 15, 16 are formed at the positions where the bottom surface and the side surface of the bottomed cavity of the conductive bodies 11, 12 intersect (cross) each other. The conductive bodies 11, 12 have insertion holes for installing the coaxial cables 13, 14 into the insertion holes. The coaxial cable 13 is installed on the conductive body 11 and the coaxial cable 14 is installed on the conductive body 12. The coaxial cables 13, 14 are arranged so that small-sized loop antennas provided on the tips of the coaxial cables 13, 14 are exposed from the bottom surfaces of the bottomed cavities at the position to face each other. The material having high conductivity is generally preferable for the conductive bodies 11, 12. The copper is used for the conductive bodies 11, 12 in the present embodiment.

The split cylinder resonator 100 of the present embodiment is the resonator for 28 GHz. The diameter D of the cavity 19 is 15.2 mm, and the height H is 10.8 mm. As for the size of the protruded portions 15, 16, the length g in the radial direction and the length h in the height direction are the same and are 0.7 mm. In the split cylinder resonator for 28 GHz, the diameter D and the height H are not necessarily determined as fixed values. In the split cylinder resonator, it is known that the range where the resonance of the other modes does not exist can be widely secured at the lower part of the resonance frequency of the TE011 mode when the ratio (D/H) between the diameter D and the height H is approximately 1.4 regardless of the frequency of the TE011 mode. Thus, the constant is selected to satisfy the above described condition also in the present embodiment. In addition, as shown in FIG. 2, the measurement sample Sa is inserted into the center of the cavity 19 so as to be sandwiched between the two conductive bodies 11, 12.

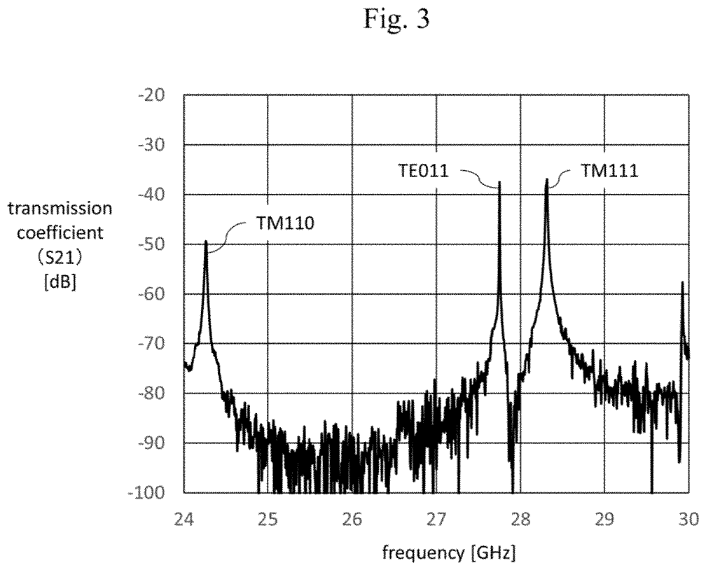

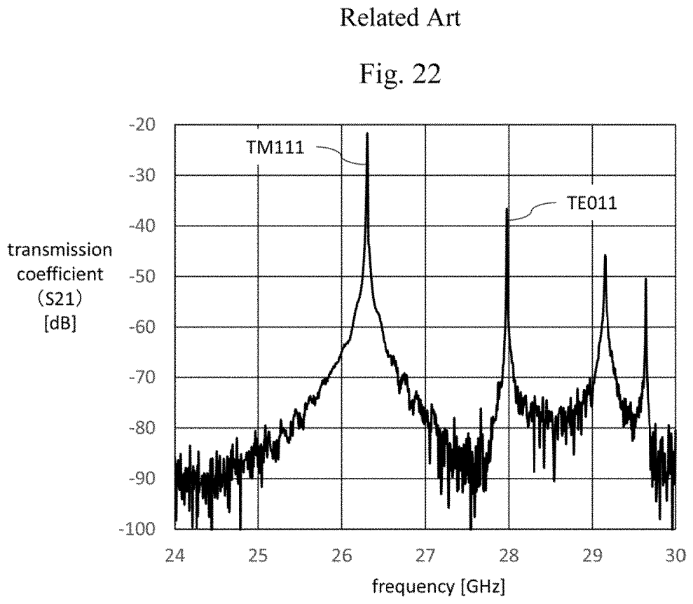

FIG. 3 is a drawing showing the resonance frequency characteristics of the split cylinder resonator (without measurement sample). The resonance frequency of the TE011 mode is located around 27.75 GHz which is close to the designed value. As expected, the resonance frequency of the TM111 mode is shifted to the frequency (around 28.32 GHz) higher than that of the TE011 mode. In the technology disclosed in Non-Patent Document 1, as shown in FIG. 22, the degenerated resonance frequency (around 28.0 GHz) of the TM111 mode is shifted to the lower frequency (around 26.3 GHz). Thus, the range within which the resonance frequency of the TE011 mode can be shifted without being overlapped with the resonance frequencies of the other modes is narrow (approximately 1.7 GHz). On the other hand, in the split cylinder resonator 100 of the present embodiment, as shown in FIG. 3, the highest resonance frequency is the TM110 mode in the range lower than the TE011 mode. Although the frequency (around 24.26 GHz) is slightly higher than the preliminarily designed frequency (24 GHz), approximately 3.5 GHz can be secured for the range of shifting the resonance frequency. Note that, same as the TM111 mode, the resonance frequency of the TM110 mode is considered to become higher by the existence of the protruded portions 15, 16 formed on the periphery of the bottom surface of the bottomed cavity of the split cylinder resonator 100.

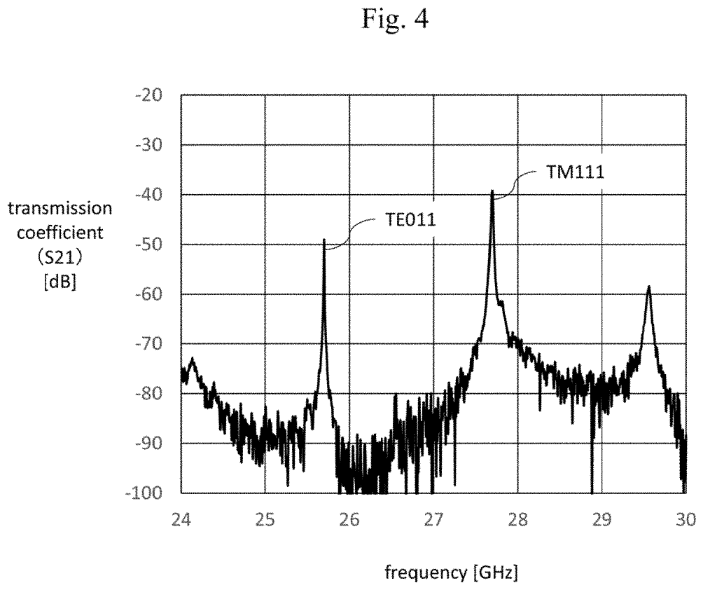

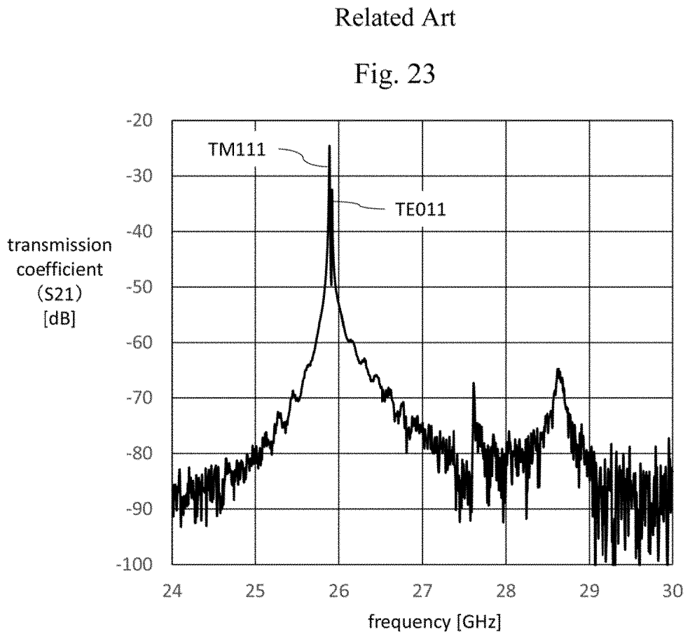

In the split cylinder resonator 100, as described above, the resonance frequency of the TE011 mode is not overlapped with the other resonance modes within the range of approximately 3.5 GHz even if the resonance frequency of the TE011 mode is shifted. Thus, the split cylinder resonator 100 can measure a wide range of samples. FIG. 4 is a drawing showing the resonance frequency characteristics when the measurement sample Sa is inserted same as the case of FIG. 23. The resonance frequency of the TE011 mode is shifted to the lower frequency (around 25.7 GHz) when the measurement sample Sa is inserted. In FIG. 23, the resonance frequency of the TE011 mode is shifted to the lower side (25.92 GHz) and almost overlapped with the resonance frequency (25.89 GHz) of the TM111 mode. Thus, the complex permittivity of the measurement sample Sa cannot be measured correctly. On the other hand, in the present embodiment, the TE011 mode is not affected by the other resonance modes. Thus, the complex permittivity of the measurement sample Sa can be measured correctly. Note that the resonance frequency of the TM110 mode is shifted to the lower side (less than 24 GHz) when the measurement sample Sa is inserted, similar to the resonance frequency (around 27.8 GHz) of the TM111 mode.

Accordingly, when the resonance frequency characteristics are measured before and after the dielectric material is set to the split cylinder resonator 100 as the measurement sample, the lowest resonance frequency in a range higher than the resonance frequency of TM110 mode can be regarded as the resonance frequency of TE011 mode. Namely, the lowest resonance frequency in the range higher than the preliminarily known resonance frequency of TM110 mode is regarded as the resonance frequency of TE011 mode and the permittivity of the dielectric material can be calculated by using the above described frequency. Thus, the complex permittivity of the measurement sample can be easily calculated by identifying the resonance frequency of the TE011 mode by using the software having the above described algorism.

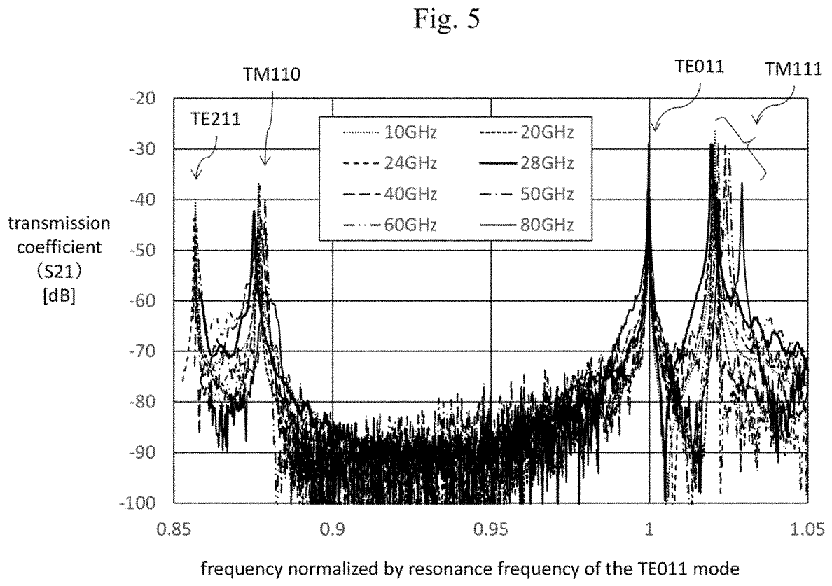

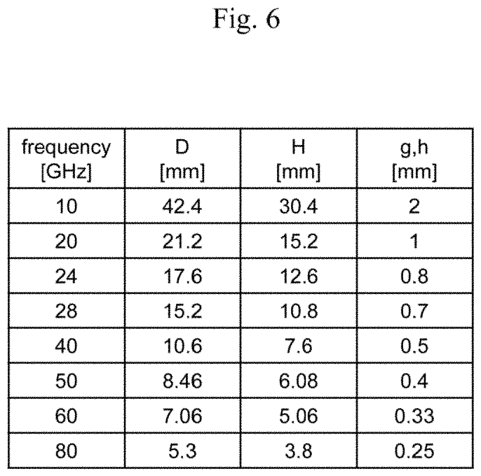

FIG. 5 is a drawing showing the resonance frequency characteristics of the split cylinder resonators having the cavity 19 of different sizes. The resonance frequency characteristics are measured by the split cylinder resonators for 10 GHz, 20 GHz, 24 GHz, 40 GHz, 50 GHz, 60 GHz and 80 GHz in addition to the split cylinder resonator 100 of 28 GHz. The sizes of the cavity (diameter D, height H) and the sizes of the protruded portion (length g in radial direction, length h in height direction) of the split cylinder resonators are shown in FIG. 6. In the split cylinder resonators, the ratio (D/H) of the diameter D with respect to the height H of the cavity 19 is approximately 1.4, the ratios (g/D, h/D) of the length g in the radial direction and the length h in the height direction of protruded portion with respect to the diameter D of the cavity are approximately 0.046. Namely, the sizes (diameter D, height H) of the cavity and the sizes (length g in radial direction, length h in height direction) of the protruded portions 15, 16 are inversely proportional to the designed values of the frequencies.

FIG. 5 is shown by normalizing the values so that the resonance frequency of the TE011 mode becomes 1. As shown in FIG. 5, it is confirmed in all split cylinder resonators that the resonance frequency of the TM111 mode is shifted to the higher frequency than the TE011 mode, the resonance located neighboring to the lower part of the TE011 mode is the TM110 mode, and the TM110 mode is located at the position approximately 12% lower than the resonance frequency of the TE011 mode. In addition, the TE211 mode exists at the lower part of the resonance frequency of the TM110 mode.

In the present embodiment, the ratio (D/H) between the diameter D and the height H of the cavity 19 is specified to approximately 1.4. However, the above described ratio is determined for obtaining the condition that the highest frequency in the other resonance modes located lower than the TE011 mode is minimally lowered. Although the above described ratio is the most desirable, even when the other ratios are used, it is not departed from the scope of the present invention.

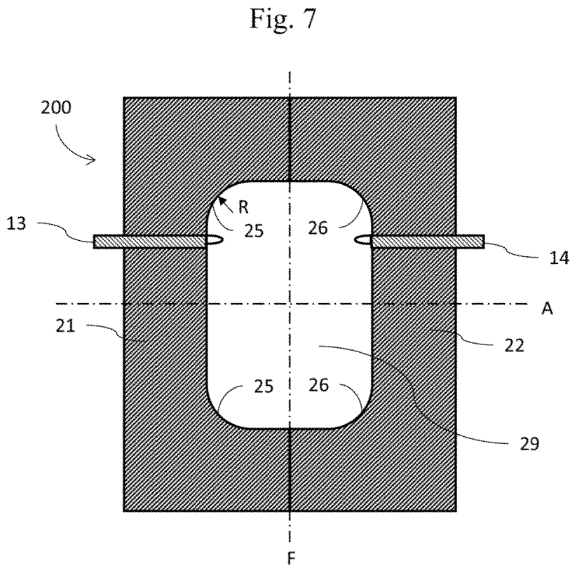

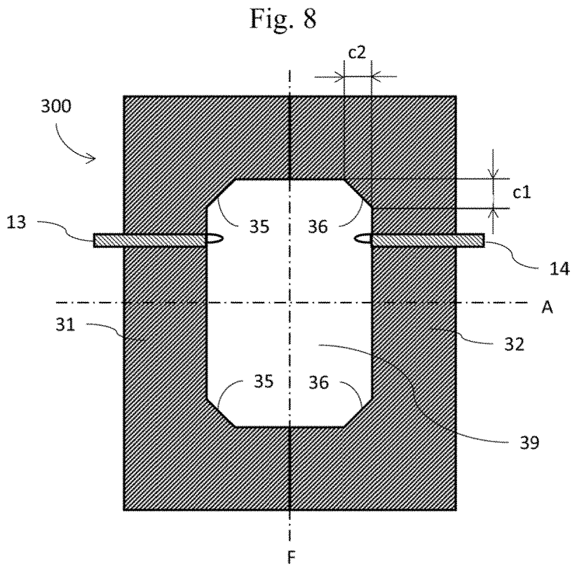

In the split cylinder resonator 100, as for the size of the protruded portions 15, 16, the length g in the radial direction and the length h in the height direction are specified to 0.7 mm, and the ratios (g/D, h/D) with respect to the diameter D of the cavity 19 are specified to approximately 0.046. This is because it is experimentally known that the adjustment of the resonance is difficult when the size is larger than the above described size. If the size is smaller than the above described size, the resonance frequencies of the TM111 mode and the TE011 mode cannot be sufficiently separated with each other. Thus, the above described length g in the radial direction and the length h in the height direction are considered to be appropriate. However, the length g and the length h can be arbitrarily changed within the range not departing from the scope of the present invention. In the split cylinder resonator 100, the cross-sectional shape of the protruded portions 15, 16 are formed in a stepwise shape (rectangular shape) considering the easiness of the milling process. However, it is not departed from the scope of the present invention even when the cross-sectional shape is formed in the rounded shape (arc shape) as shown in FIG. 7, a triangle shape as shown in FIG. 8 or other shapes.

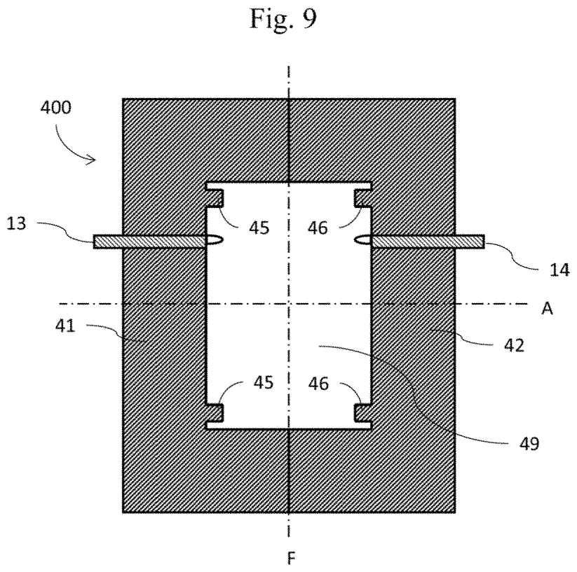

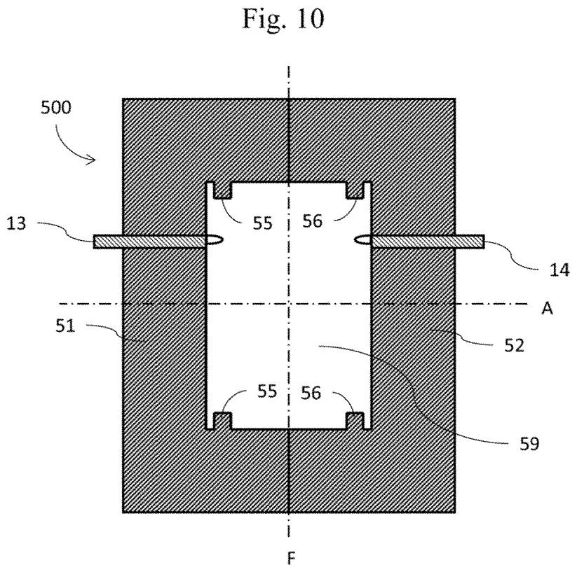

In the above described protruded portions 15, 16 of the split cylinder resonator 100, the bottom surface and the side surface of the bottomed cavity of the conductive bodies 11, 12 intersect to form a corner. However, it is not necessary to form the corner. For example, as shown in FIGS. 9, 10, the protruded portions can be formed near the corner where the bottom surface and the side surface intersect so that a part of the conductive body is protruded from the bottom surface or the side surface facing the integrated cavity of the conductive body toward the integrated cavity. In a split cylinder resonator 400 shown in FIG. 9, protruded portions 45, 46 are formed from the bottom surface facing a cavity 49 of conductive bodies 41, 42 toward the cavity 49. In a split cylinder resonator 500 shown in FIG. 10, protruded portions 55, 56 are formed from the side surface facing a cavity 59 of conductive bodies 51, 52 toward the cavity 59.

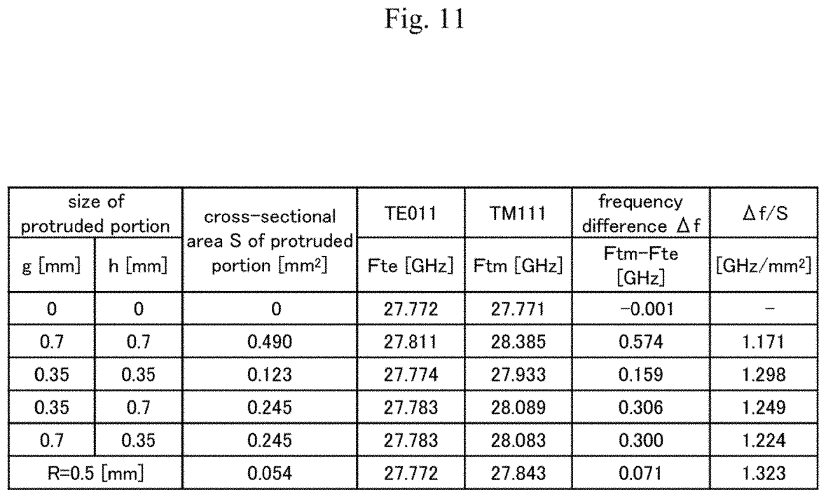

The relation between the shape of the protruded portion and the resonance frequency will be considered. FIG. 11 is a table showing the relation between the cross-sectional area of the protruded portion and the resonance frequency of the split cylinder resonator. FIG. 11 shows the deviation amount (frequency difference Δf) of the resonance frequencies between the TE011 mode and the TM111 mode when the size and shape of the protruded portion are changed. When the cross-section cut along the plane passing through the center axis of the cylindrical cavity of the split cylinder resonator is considered, the cross-sections of the protruded portion can be seen at four positions as shown in FIGS. 1, 7-10 and the shapes of the cross-sections are substantially same in four positions. Thus, the cross-sectional area S (e.g., length g in the radial direction×length h in height direction) of one of the cross-sections will be considered for the purpose of simplicity.

As shown in FIG. 11, when the protruded portion is not formed (g=h=0), the resonance frequencies of the TE011 mode and the TM111 mode are degenerated and the deviation amount is approximately 0. In the split cylinder resonator 100 shown in FIG. 1, the deviation amount is approximately 0.574 GHz as shown in FIG. 11. When the protruded portion is formed and the length g in the radial direction and the length h in the height direction are 0.35 mm, the deviation amount is approximately 0.159 GHz. When the protruded portion is formed and the length g in the radial direction is 0.35 mm and the length h in the height direction is 0.7 mm, the deviation amount is approximately 0.306 GHz. When the protruded portion is formed, the length g in the radial direction is 0.7 mm and the length h in the height direction is 0.35 mm, the deviation amount is approximately 0.300 GHz. When the radius R is specified to 0.5 mm and the protruded portion is formed in the rounded shape (arc shape) as shown in FIG. 7, the deviation amount is approximately 0.071 GHz.

In the resonance frequency characteristics of the split cylinder resonator 100 (g=h=0.7 mm) shown in FIG. 3, the deviation amount between the resonance frequency (approximately 27.75 GHz) of the TE011 mode and the resonance frequency (approximately 28.32 GHz) of the TM111 mode is approximately 0.57 GHz as described above. Although there is an error due to the processing accuracy of the cavity and the protruded portion, the deviation amount almost always coincides with the deviation amount (approximately 0.574 GHz) shown in FIG. 11.

When the deviation amount with respect to the cross-sectional area S of the protruded portion is calculated (frequency difference Δf [GHz]/cross-sectional area S [mm²]), the deviation amount is almost constant and is 1.171 to 1.323 GHz (average value: approximately 1.25 GHz) as shown in FIG. 11. Thus, it can be considered that the deviation amount of the resonance frequencies between the TE011 mode and the TM111 mode is proportional to the cross-sectional area of the protruded portion.

As described in the background of the invention, if the resonance frequencies of the TE011 mode and the TM111 mode are overlapped with each other in the resonance frequency characteristics before inserting the sample into the split cylinder resonator, an error is caused when measuring the resonance frequency in TE011 mode under the influence of the TM111 mode. As a result, the value of the permittivity is incorrectly measured. Namely, when the deviation amount between the resonance frequencies of the TE011 mode and the TM111 mode is small, the skirt of the TM111 mode is overlapped with the TE011 mode and the error appears on the measured value. Therefore, how much deviation amount of the resonance frequency is required for eliminating the influence when measuring the complex permittivity will be considered. In this consideration, in order to correspond to the measured value of the actually manufactured split cylinder resonator 100, the amplitude of the TM111 mode is specified to be same as the amplitude of the TE011 mode, and the Q-factor is specified to be twice the Q-factor of the TE011 mode.

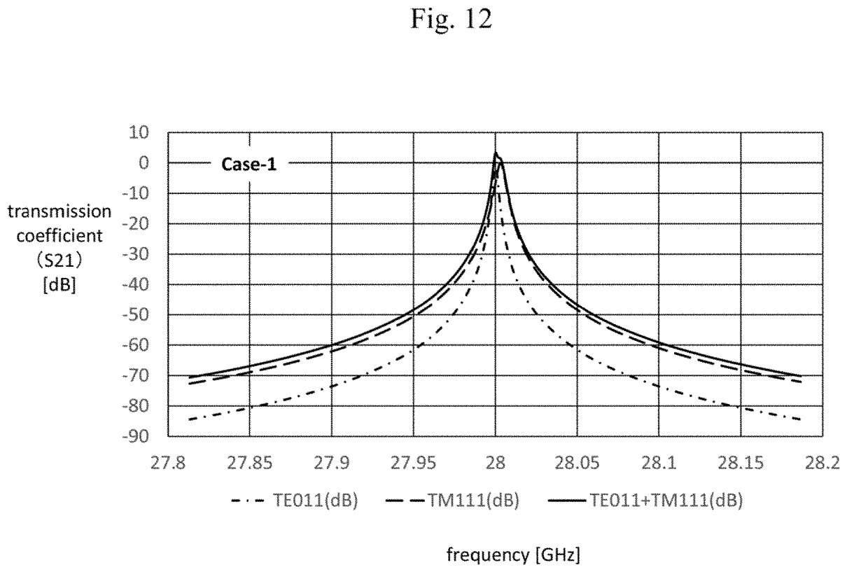

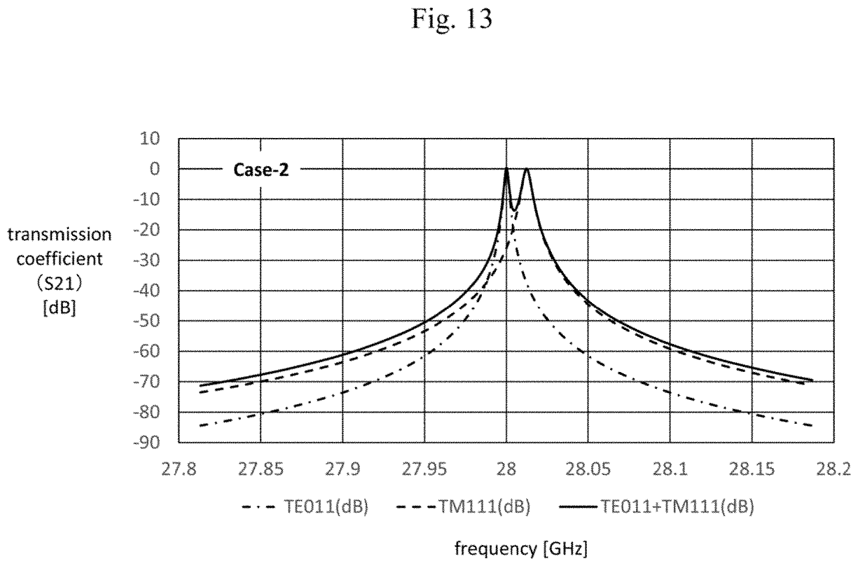

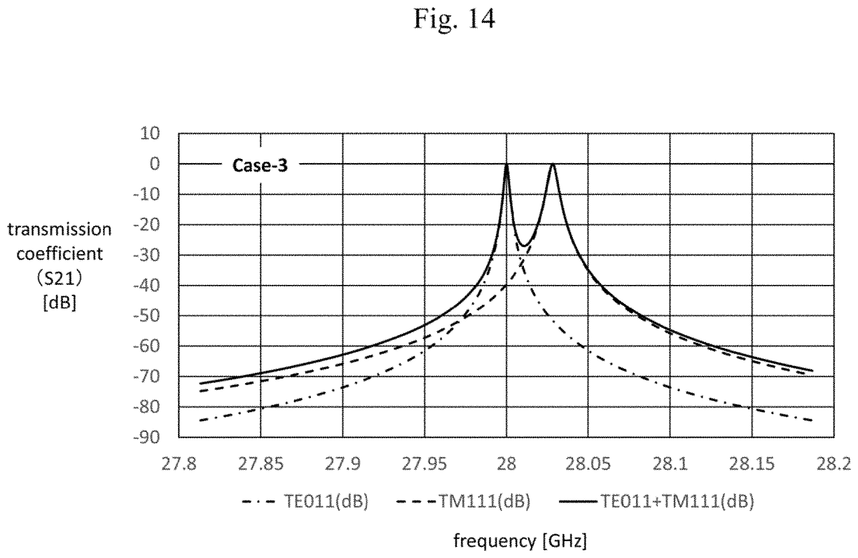

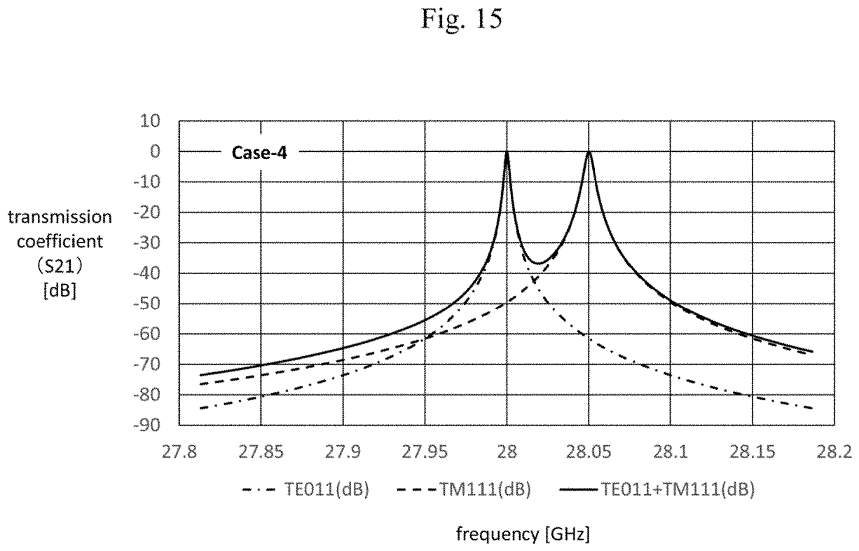

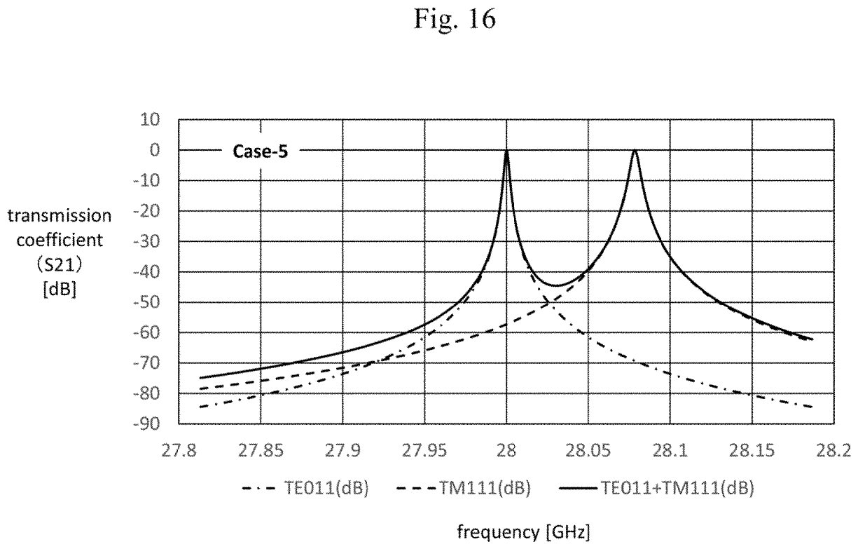

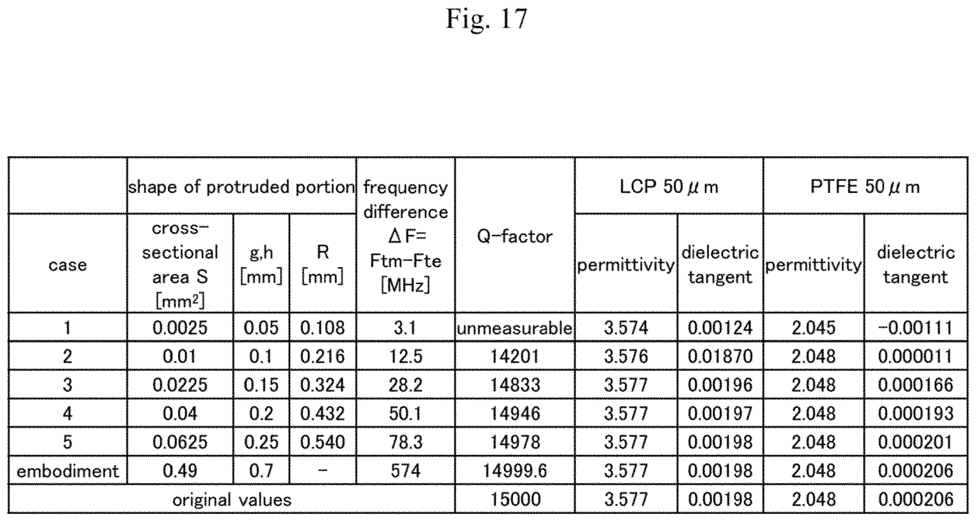

FIG. 12 to FIG. 16 are drawings showing the resonance frequency characteristics by calculation in a state that the deviation amount of the resonance frequencies between the TE011 mode and the TM111 mode is 3.1 MHz (case 1), 12.5 MHz (case 2), 281 MHz (case 3), 50.1 MHz (case 4), and 78.3 MHz (case 5) respectively. FIG. 17 is a table showing the calculation result of the cases 1-5 compared with the values of the measurement result (embodiment) of the split cylinder resonator 100 and the original values. As the sample for the original values, LCP (liquid crystal polymer) and PTFE (polytetrafluoroethylene) having the thickness of 50 μm are used since the values of the permittivity and the dielectric tangent are preliminarily known.

In the case 1, it is apparent that the center frequency and the Q-factor of the TE011 mode cannot be correctly obtained. Thus, the permittivity of the sample cannot be measured correctly in the above described state. Even if the values are unjustly applied to the calculation formula, meaningless results are obtained (e.g., the dielectric tangent becomes a minus value).

In the case 2, the center frequency and the Q-factor of the TE011 mode can be calculated. From the calculation, it is known that the center frequency is not significantly deviated and not likely to cause problems. However, the Q-factor is calculated as 14,201 although the value is originally 15,000. This is because of the error caused when the skirt of the TM111 mode is overlapped with the TE011 mode. If the Q-factor of the TE011 mode is measured as 14,201 although it is originally 15,000, the permittivity of PTFE having the thickness of 50 μm is measured as 2.048 and the dielectric tangent is measured as 0.000011 although it originally has the properties of the permittivity of 2.048 and the dielectric tangent of 0.000206.

Similarly, the permittivity of the LCP having the thickness of 50 μm is measured as 3.576 and the dielectric tangent is measured as 0.000187 although it originally has the permittivity of 3.577 and the dielectric tangent of 0.00198. Although the measurement of the permittivity is not affected much, the error of the dielectric tangent appears a lot and the measurement error is unacceptable.

In the case 3, although the error of the dielectric tangent of PTFE exceeds the acceptable range, the LCP can be measured without large problems since the dielectric tangent is originally large in the LCP. Also in the case 4, the dielectric tangent of the PTFE is deviated from the original value.

Also in the case 5, although the error can be seen a little, the case 5 can be actually judged to have enough accuracy without error since the errors caused by other factors are more significant. In the split cylinder resonator 100 of the present embodiment, the deviation amount between the resonance frequencies of the TE011 mode and the TM111 mode is approximately 574 MHz. Thus, it can be said that the error is not caused at all in the present embodiment.

As described above, it can be judged that there is no problem for measuring the LCP in the deviation amount of the case 3, and the deviation amount of the case 4 or the case 5 is required for accurately measuring the PTFE which has an extremely small dielectric loss. Accordingly, approximately 28.2 MHz of the deviation amount between the resonance frequencies of the TE011 mode and the TM111 mode is required for measuring at least the LCP of the case 3.

FIG. 17 shows the cross-sectional area S of the protruded portion corresponding to the deviation amount between the resonance frequencies of the TE011 mode and the TM111 mode, the length g in the radial direction and the length h in the height direction when the protruded portion is formed in a rectangular shape, and a length of the radius R when the protruded portion is formed in a rounded shape. As shown in the consideration using FIG. 11, the deviation amount of approximately 1.25 GHz can be obtained per the unit area 1 mm² of the cross-sectional area S of the protruded portion. Thus, 0.0225 mm² of the cross-sectional area S of the protruded portion is required to obtain the deviation amount of 28.2 MHz of the case 3, for example. As described above, since the protruded portions can be seen at four positions in the cross-section, the required total cross-sectional area S4 of the protruded portion is 0.09 mm².

When the bottomed cavity is formed for manufacturing the conductive body of the split cylinder resonator, the rounded shape of 0.05 mm or less is normally formed at the corner where the bottom surface and the side surface of the bottomed cavity intersect due to the restriction on accuracy of the milling process. However, even if the rounded shape of approximately 0.05 mm is formed on the corners of the bottomed cavity, the effect of the present invention cannot be obtained as shown in FIG. 17. When the protruded portion of the split cylinder resonator of the present embodiment is formed in the rounded shape, since the radius R is 0.3 mm or more as shown in FIG. 17 (case 3), the protruded portion should be intentionally formed to obtain the effect of the present invention.

Although the above described consideration is made for the case of the split cylinder resonator 100 of 28 GHz, the same consideration can be applied to the split cylinder resonator of other frequencies. Namely, the diameter D and the height H of the cavity of the split cylinder resonator are almost inversely proportional to the frequency, and the value of the cross-sectional area S of the protruded portion required for obtaining the effect of the present invention varies proportional to the product of the diameter D and the height H of the cavity (i.e., the cross-sectional area of the cavity when the protruded portion is not formed). In case of the split cylinder resonator 100 of 28 GHz, the diameter of the cavity is D=15.2 mm and the height of the cavity is H=10.8 mm, the ratio of the total cross-sectional area S4 (0.09 mm²=0.0225 mm²×4) of the required minimum protruded portion with respect to the product of the diameter D and the height H of the cavity is approximately 0.0548% (0.09/(15.2×10.8)). Accordingly, the total cross-sectional area S4 of the required protruded portion of the split cylinder resonator of other frequencies (other sizes) is equal to or more than 0.0548% of the product of the diameter D and the height H of the cavity of the split cylinder resonator.

### INDUSTRIAL APPLICABILITY

The split cylinder resonator and the method of calculating the complex permittivity of the present invention is suitable for measuring the complex permittivity of the dielectric material in a microwave and millimeter wave bands.

### DESCRIPTION OF THE REFERENCE NUMERALS

100, 200, 300, 400, 500, 800, 900: split cylinder resonator
11, 12, 21, 22, 31, 32, 41, 42, 51, 52, 81, 82, 91, 92: conductive body
13, 14: coaxial cable
15, 16, 25, 26, 35, 36, 45, 46, 55, 56: protruded portion
95, 96: groove
19, 29, 39, 49, 59, 89, 99: cavity
Sa: measurement sample

What is claimed is:

1. A split cylinder resonator, comprising:
a first conductive body having a first cavity formed in a cylindrical shape having the side surface and the bottom surface;
a second conductive body having a second cavity formed in a cylindrical shape having the side surface and the bottom surface, the second conductive body being arranged so that the second cavity faces the first cavity;
a first coaxial cable having a first loop antenna at a tip of the first coaxial cable, the first loop antenna being arranged so as to be exposed to an integrated cavity which is formed by the first cavity and the second cavity; and
a second coaxial cable having a second loop antenna at a tip of the second coaxial cable, the second loop antenna being arranged so as to be exposed to the integrated cavity, the second coaxial cable being arranged so as to face the first coaxial cable, wherein
the first conductive body and the second conductive body have a protruded portion protruded from a part of at least one of the side surface and the bottom surface of the first conductive body and the second conductive body toward the integrated cavity.

2. The split cylinder resonator according to claim 1, wherein
the protruded portion is located at a position where the side surface and the bottom surface intersect with each other.

3. The split cylinder resonator according to claim 1, wherein
a total cross-sectional area of the protruded portion is 0.0548% or more with respect to a product of the diameter and the height of the integrated cavity when cut by a plane passing through a central axis of the integrated cavity.

4. A method of calculating a permittivity of a dielectric material as a measurement sample using a split cylinder resonator, the method comprising:
a step of obtaining a first resonance characteristics before the dielectric material is set to the split cylinder resonator;
a step of obtaining a second resonance characteristics after the dielectric material is set to the split cylinder resonator;
a step of judging the lowest resonance in a range higher than a preliminarily known resonance frequency of TM110 mode and regarding the judged resonance as the resonance of TE011 mode; and
a step of calculating the permittivity of the dielectric material based on the first resonance characteristics and the second resonance characteristics.
